(19) United States
(12) Patent Application Publication
(10) Pub. No.: US 2006/0232649 A1
(43) Pub. Date: Oct. 19, 2006

(54) Ink cartridge for inkjet printer

(76) Inventors: Jun-Zhong Wu, Zhuhai (CN); Yang-Yun Zeng, Zhuhai (CN); Yi-Ding Yu, Zhuhai (CN)

Correspondence Address: John Chen, Room 303, 3F, No.25, Sec 1, Changan E. Road, Taipei, 10411, TW

(21) Appl. No.: 11/450,352

(22) Filed: Jun. 12, 2006

Related U.S. Application Data
(63) Continuation of application No. PCT/IB05/00140, filed on Jan. 18, 2005.

(51) Int. Cl. B41J 2/175

(52) U.S. Cl. 347/86

(57) ABSTRACT

An ink cartridge for an inkjet printer includes a top cover, a bottom wall, a handle, an ink chamber, an air inlet, an ink supply port. The air inlet is disposed at the top of the ink chamber, such that the ink chamber is communicated with the atmosphere. A labyrinth capillary is disposed at the side surface of the bottom wall, with one end in communication with the bottom portion of the ink chamber and the other end in communication with the cavity for accommodating elongated fiber bundles. The ink supply port is disposed at the bottom of the cavity for accommodating elongated fiber bundles, and the elongated fiber bundles are accommodated in the cavity. The present invention has the following advantages of greatly reducing the residual ink, improving the printing yield, and reducing the manufacturing cost; reducing the waste, thereby benefiting for environment protection; and accomplishing the mass production, thereby enhancing the qualification rate.

### BACKGROUND OF THE INVENTION

1. Field of Invention

The present invention relates to a simple and effective ink cartridge for an inkjet printer for stably supplying ink.

2. Description of Related Art

Currently, commercially available ink cartridges can be divided into two types in the following.

A. A porous material is used to store ink and fiber bundles are used to obstruct leakage and smoothly supply ink, which is the patent right issued to CANON.

B. The fluency in supplying ink is controlled by a non-return valve or a pressure-control mechanism and fiber bundles.

However, the above two types (A and B) of ink cartridges have the following disadvantages.

1. The porous material and the fiber bundles occupy relative large space of the ink-storage chamber, resulting in a decrease in the printing yield and an increase in the manufacturing cost.

2. A certain amount of ink is remained in the porous material and the fiber bundles, thus causing a waste and doing harm to the environment.

3. The pressure of this type of ink cartridge is low and it is hard to control this ink cartridge, and thus it is not suitable for mass production and it is difficult to control the quality and the yields is relatively low.

### SUMMARY OF THE INVENTION

An objective of the present invention is to provide a practicable and highly effective ink cartridge for an inkjet printer. Under the control of the elongated fiber bundles and labyrinth capillary grooves, the ink cartridge can reliably and stably supply ink, thus controlling the whole printing process.

The ink cartridge for an inkjet printer in the present invention comprises a top cover, a bottom wall, a handle, an ink chamber, an air inlet, and an ink supply port. The air inlet is disposed at the top of the ink chamber whereby the ink chamber is communicated with the atmosphere. A labyrinth capillary is disposed at a side surface of the bottom wall, with one end in communication with the bottom of the ink chamber and the other end in communication with the middle portion of the cavity for accommodating elongated fiber bundles. The ink supply port is disposed at the bottom of the cavity for accommodating elongated fiber bundles, and the elongated fiber bundles are accommodated within the cavity. The elongated fiber bundles are disposed in the cavity for accommodating elongated fiber bundles from top to bottom, and extend to the ink supply port, so as to firmly contact the inner wall of the cavity for accommodating elongated fiber bundles. The communication hole communicating the labyrinth capillary and the cavity for accommodating elongated fiber bundles does not directly contact the elongated fiber bundles, and an interval exists therebetween. The handle is a separated workpiece made of an elastic material, and the handle in an inverted-hook shape is disposed at the top portion of the bottom wall from top to bottom. An air inlet labyrinth groove and an ink leak-proof device are disposed on the top cover, and an ink inject hole is disposed at the top cover on top of the cavity for accommodating elongated fiber bundles. The labyrinth capillary is formed by soldering a sealing film on the labyrinth capillary groove at a side surface of the bottom wall.

Before installing the ink cartridge, the air inlet labyrinth is opened, such that the air enters the ink chamber of the ink cartridge from the air inlet labyrinth via the ink leak proof mechanism, thereby keeping the ink chamber at a normal atmosphere pressure. After installing the ink cartridge, elongated fiber bundles are firmly pressed against the ink inlet of the print-head, and meanwhile the ink supply port of the ink cartridge and the print-head are sealed. In order to prevent ink leaking in use caused by the change of the environmental temperature, one end of the labyrinth capillary is communicated with the bottom of the ink chamber, and the other end is communicated with the middle portion of the cavity for accommodating elongated fiber bundles. Thus, the elongated fiber bundles can steadily supply ink to the print-head when the ink cartridge starts printing. At this time, the negative pressure in the cavity for accommodating elongated fiber bundles rises, and under the slight pressure, the ink within the ink chamber flows to the elongated fiber bundles along the labyrinth capillary for compensating ink, thereby maintaining the ink contained by the elongated fiber bundles in a relatively stable proportion, and the air enters the ink chamber along the air-inlet labyrinth.

The present invention has the following advantages of:

1. greatly reducing the residual ink, improving the printing yield, and reducing the manufacturing cost;

2. reducing the waste, thereby benefiting for environment protection; and

3. accomplishing the mass production, thereby enhancing the qualification rate.

In order to make the aforementioned and other objectives, features and advantages of the present invention comprehensible, preferred embodiments accompanied with figures are described in detail below.

### BRIEF DESCRIPTION OF THE DRAWINGS

FIG. 1 is a schematic sectional view of a structure of the present invention.

FIG. 2 is a schematic top view of the structure in FIG. 1.

FIG. 3A is a schematic view when the ink cartridge has been completely mounted in the print-head bracket.

FIG. 3B is a schematic view when the ink cartridge is just mounted into the print-head bracket.

FIG. 4 is a sectional view when the ink cartridge has been completely mounted in the print-head bracket.

### DESCRIPTION OF THE PREFERRED EMBODIMENTS

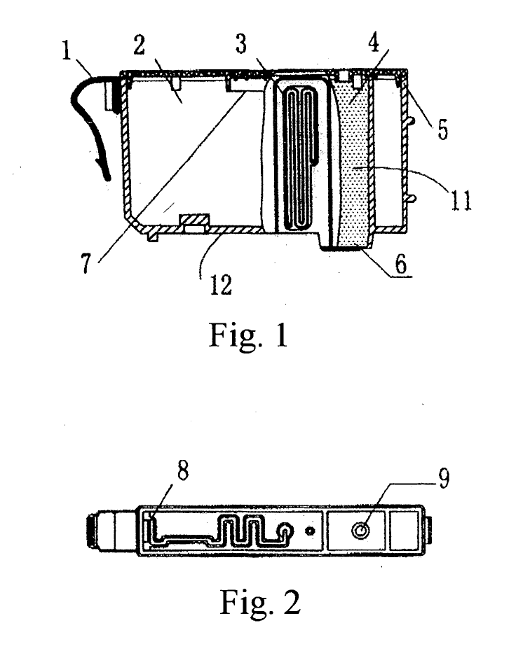

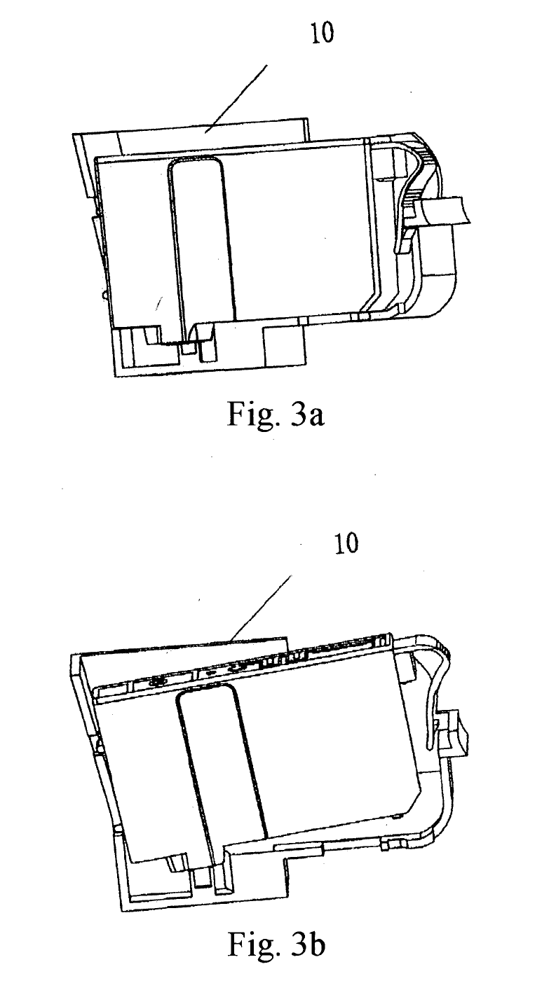

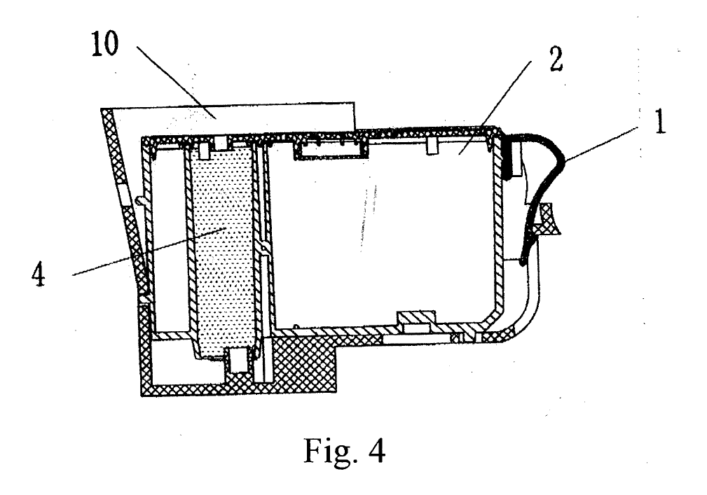

As shown in FIG. 1, FIG. 2, FIG. 3A, FIG. 3B, and FIG. 4, the ink cartridge for an inkjet printer in the present invention comprises a top cover 5, a bottom wall 12, a handle 1, an ink chamber 2, an air inlet 8, an ink supply port 6. The air inlet 8 is disposed at top of the ink chamber 2, such that the ink chamber 2 is communicated with the atmosphere. The labyrinth capillary 3 is disposed at the side surface of the bottom wall 12, with one end in communication with the bottom of the ink chamber 2 and the other end in communication with the middle portion of the cavity 11 for accommodating elongated fiber bundles. The ink supply port 6 is disposed at the bottom of the cavity 11 for accommodating elongated fiber bundles, and the elongated fiber bundles 4 are accommodated therein. The elongated fiber bundles 4 are disposed in the cavity 11 for accommodating elongated fiber bundles from top to bottom, and extend to the ink supply port 6, thereby firmly contacting the inner wall of the cavity 11 for accommodating elongated fiber bundles. The communication hole communicating the labyrinth capillary 3 and the cavity 11 for accommodating elongated fiber bundles does not directly contact the elongated fiber bundles 4, and an interval exists therebetween. The handle 1 is a separated workpiece made of elastic material, and the handle 1 in an inverted-hook shape is disposed at the top portion of the bottom wall from top to bottom. An air-inlet labyrinth groove 8 and an ink leak-proof device 7 are disposed on the top cover 5, and an ink inject hole 9 is disposed at the top cover on top of the cavity 11 for accommodating elongated fiber bundles. The labyrinth capillary is formed by soldering a sealing film on the labyrinth capillary groove at a side surface of the bottom wall.

Before installing ink cartridge, the air-inlet labyrinth 8 is opened, such that the air enters the ink chamber 2 of the ink cartridge from the air inlet labyrinth 8 via the ink leak proof mechanism 7, thereby keeping the ink chamber 2 at the normal atmosphere pressure. After installing the ink cartridge, elongated fiber bundles 4 are firmly pressed against the ink inlet of the print-head, and meanwhile the ink supply port 6 of the ink cartridge and the print-head are sealed. When the ink cartridge starts printing, the elongated fiber bundles 4 can steadily supply ink to the print-head. At this time, the negative pressure in the cavity 11 for accommodating elongated fiber bundles rises, and under the slight pressure, the ink within the ink chamber 2 flows to the elongated fiber bundles 4 along the labyrinth capillary 3 for compensating ink, thereby maintaining the ink contained by the elongated fiber bundles 4 in a relatively stable proportion, and the air enters the ink chamber along the air-inlet labyrinth 8.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An ink cartridge for an inkjet printer, comprising: a top cover, a bottom wall, a handle, an ink chamber, an air inlet, and an ink supply port, wherein an air inlet is disposed at the top of the ink chamber whereby the ink chamber is communicated with the atmosphere; a labyrinth capillary is disposed at a side surface of the bottom wall, with one end in communication with the bottom portion of the ink chamber and the other end in communication with the middle portion of the cavity for accommodating elongated fiber bundles; an ink supply port is disposed at the bottom of the cavity for accommodating elongated fiber bundles, and the elongated fiber bundles are accommodated in the cavity.

2. The ink cartridge for an inkjet printer as claimed in claim 1, wherein the elongated fiber bundles are disposed in the cavity for accommodating elongated fiber bundles from top to bottom, and extend to the ink supply port, so as to firmly contact the inner wall of the cavity for accommodating elongated fiber bundles.

3. The ink cartridge for an inkjet printer as claimed in claim 1, wherein an interval exists between the communication hole communicating the labyrinth capillary and the cavity for accommodating elongated fiber bundles and the elongated fiber bundles.

4. The ink cartridge for an inkjet printer as claimed in claim 1, wherein the handle is a separated workpiece made of elastic material, and the handle in an inverted-hook shape is disposed at the top portion of the bottom wall from top to bottom.

5. The ink cartridge for an inkjet printer as claimed in claim 1, wherein an air inlet labyrinth groove and an ink leak-proof device are disposed on the top cover, and an ink inject hole is disposed on the top cover on top of the cavity for accommodating elongated fiber bundles.

6. The ink cartridge for an inkjet printer as claimed in claim 1, wherein the labyrinth capillary is formed by soldering a sealing film on the labyrinth capillary groove at the side surface of the bottom wall.

7. The ink cartridge for an inkjet printer as claimed in claim 2, wherein the labyrinth capillary is formed by soldering a sealing film on the labyrinth capillary groove at the side surface of the bottom wall.

8. The ink cartridge for an inkjet printer as claimed in claim 3, wherein the labyrinth capillary is formed by soldering a sealing film on the labyrinth capillary groove at the side surface of the bottom wall.

9. The ink cartridge for an inkjet printer as claimed in claim 4, wherein the labyrinth capillary is formed by soldering a sealing film on the labyrinth capillary groove at the side surface of the bottom wall.

10. The ink cartridge for an inkjet printer as claimed in claim 5, wherein the labyrinth capillary is formed by soldering a sealing film on the labyrinth capillary groove at the side surface of the bottom wall.
